(19) United States
(12) Patent Application Publication
(10) Pub. No.: US 2006/0131550 A1
(43) Pub. Date: Jun. 22, 2006

(54) Waterproofing methods and articles made thereby

(76) Inventors: David Glassel, Spring, TX (US); Gary Ernest Mellema, Grapevine, TX (US)

Correspondence Address: Martin L. McGregor, 26415 Oak Ridge Drive, Spring, TX, 77380, US

(21) Appl. No.: 11/016,609

(22) Filed: Dec. 17, 2004

(51) Int. Cl. C08L 67/00

(52) U.S. Cl. 252/607; 524/601

(57) ABSTRACT

The invention provides a method for waterproofing cellulose fibers that comprises contacting with the cellulose fibers to be treated with a copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and maintaining the contact for a time sufficient to establish a change in the chemical structure of a portion of the cellulose fiber that provides a decrease in the hydrophilic quality of the fiber decreasing the wetting of the surface by liquid water.

### TECHNICAL FIELD

This invention provides methods for waterproofing cellulose fiber materials, particularly wood. The invention also provides novel waterproof articles of manufacture.

### BACKGROUND OF THE INVENTION

Preservation of construction materials by treatment with various agents has been practiced for many years. Among the earliest treatments was the application of tars or creosotes to wood such as railway ties that would be in contact with the earth. A wide variety of wood treatments are known that recognize the desirability of reducing the fluctuation of wood moisture content with changes in the humidity or water content of the environment of the wood. Among the various agents are silicon-based siloxanes, silanes and methylsilioxanes. One approach focuses on surface coatings such as paints stains, varnishes and sealants. These methods treat the surface of the material to be protected but do not fully penetrate the wood. Whenever the coating is broken or flawed the protective effect is decreased. Since the protection is localized on the surface, it is subject to weathering and as the coating is broken down, for example by mechanical abrasion or ultraviolet radiation damage, the protection is gradually lost. Typical examples of this group are U.S. Pat. Nos. 5,413,867; 5,354,832; 5,085,695; 4,913,972, and references cited therein. These patents teach the use of organosilanes and organosilicates for the preparation of coating materials, but do not focus on the goal of the present invention, modification of the internal structure of the wood to exclude moisture.

Modification of wood by treatment with siloxanes is disclosed in U.S. Pat. No. 5,652,026 and references cited therein. This approach focuses on altering wood to increase its fire resistance and only incidentally mention the additional benefits of increased dimensional stability derived from excluding water from the cellulose fiber structure. The methylsiloxanes disclosed require the presence of a boron or phosphorus function, while the references cited therein focused on formation of inorganic complexes with metal alkoxides within the wood cells. None of the references recognized that changing the surface activity of cellulose or lignocellulose structures with simple carbon substituted siloxanes would produce the beneficial results sought while avoiding the use of potentially toxic materials such as the metal salts, phosphorus and boron compounds.

Another use of siloxane reagents to modify wood or cellulose materials is found in U.S. Pat. Nos. 5,204,186 and 5,120,581. These patents teach a very broad group of compounds useful as fire retardants. These patents also note the additional benefits derived by moisture reduction in the treated materials. The silioxane materials disclosed require either at least a group in each molecule that contains a halogen, or a group having a silicon bond that requires less than 72 kcal/mole to break. Neither of these requirements is present in the compounds of the present invention.

U.S. Pat. No. 6,303,234 involves a process of imparting fire retardant properties to a cellulosic material comprising coating a cellulosic material with sodium silicate by contacting a sodium silicate solution with the material to be coated, dehydrating the coating, and depositing a coating of a silicon oxide glassy film on the sodium silicate coated material. In one embodiment, the coating of silicon oxide is a monomolecular layer of silicon monoxide. The “water glass” or liquid sodium silicate is a salt of silicic acid, and while it may include polysilicates is quite different from the siloxane polymers of the present invention.

No art was found that teaches altering the internal surfaces of the pore structure of the wood by contacting the wood with a mixture that alters the surface of the internal pores present in the wood to reduce the hydrophilic character of the surface and thereby reduce the penetration of water by contacting the wood with a siloxane polymer optionally diluted with a hydrocarbon solvent carrier, and optionally a naturally occurring oil. A method and composition to practice the novel treatment are described below, and produce novel articles of manufacture are set out below.

### SUMMARY OF THE INVENTION

The invention provides a method for waterproofing cellulose fibers that comprises contacting with the cellulose fibers to be treated with a copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and maintaining the contact for a time sufficient to establish a change in the cellulose fiber that provides a decrease in the hydrophilic quality of the fiber decreasing the wetting of the fiber by liquid water. Preferably the method further comprises mixing a cross-linking agent with the copolymer that comprises a siloxane polymer of the general formula: (MₐD_{b}T_{c}Q_{d})ₓ meeting the following parameters apply: the ratio of a/(c+d) is between 0 and 4; the ratio of b to the rest is not subject to limitation provided the final cross-linking agent viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable. It is also preferred to provide a crosslinking catalyst mixed with the copolymer. Any crosslinking catalyst known in the art may be used however preferred catalysts are tetraalkyl titanates or tetraalkyl zirconates where the alkyl groups may be the same or different. Because the viscosity of the copolymer may decrease or prevent penetration in some cellulose fiber materials, it is optionally desirable to dilute the copolymer with a hydrocarbon solvent. Although any hydrocarbon solvent that carries the copolymer into cellulose fiber structures, such as wood, may be used the preferred solvents are aliphatic solvents composed primarily of C₇-C₁₆ paraffinic, cycloparaffinic and isoparaffinic hydrocarbons containing less than about 0.5% aromatic hydrocarbons. More preferably, the aliphatic solvent is composed primarily of C₉-C₁₄, paraffinic, cycloparaffinic and isoparaffinic hydrocarbons and of those range of C₁₀-C₁₃ is preferred. The current most preferred solvent is Conosol 145 marketed by Penreco, Inc, of Houston, Tex. Optionally additional benefits maybe obtained by adding to the treatment mixture a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil. Preferred oils are cedar oil, cinnamon oil, citronella oil, clove oil, eucalyptus oil, juniper oil, tall oil, and pine oil. The most preferred oil is cedar oil.

In the copolymer the R groups may be the same or different and each is a lower alkyl group preferably of no more that four carbons. Especially preferred are those copolymers wherein all non-terminal copolymer R groups are methyl. In the preferred cross-linking agent, each has an R group in an alkoxy group that is an alkyl group comprising from 1 to 4 carbon atoms. Especially preferred cross-linking agents further comprise methyl groups at each non-alkoxy position.

The invention also provides novel articles of manufacture comprising cellulose fibers processed according to the various embodiments summarized above.

### DETAILED DESCRIPTION OF THE INVENTION

### Definitions

### General Description of the Invention

In order to understand the invention at its most basic level it is importation to understand the basic properties of cellulose fibers and particularly the structure of their most abundant source, wood. According to a standard text, “Construction: Principles, Materials, and Methods” by Simmons, H. Leslie.; Olin. Harold Bennett, New York, N.Y., John Wiley & Sons. Inc. (US), 2001, Chapter 6 page 366 et seq., {Cited below as Simmons et al. } (Captions deleted from quotation. “ . . . ” indicates deletions other than captions and [ ] indicates insertions or change in case), “ . . . [w]ood cells, or fibers, are primarily cellulose cemented together with lignin. The wood structure is about 70% cellulose, between 12% and 28% lignin, and up to 1% ash-forming materials. These constituents give wood its hygroscopic properties, its susceptibility to decay, and its strength. The bond between individual fibers is so strong that when tested in tension they commonly tear apart rather than separate. The rest of wood, although not part of its structure, consists of extractives that give different species distinctive characteristics such as color, odor, and natural resistance to decay.

It is possible to dissolve the lignin in wood chips using chemicals, thus freeing the cellulose fibers. By further processing, these fibers can then be turned into pulp from which paper and paperboard products are made. It is also possible to chemically convert cellulose so that it may be used to make textiles (such as rayon), plastics, and other products that depend on cellulose derivatives.

Wood is hygroscopic, meaning that it expands when it absorbs moisture and shrinks when it dries or loses moisture. This property affects the end use of wood. Although the wet (green) condition is normal for wood throughout its life as a tree, most products made of wood require that it be used in a dry condition; therefore, seasoning by drying to an acceptable moisture content is necessary.

The moisture content of wood is the weight of water it contains, expressed as a percentage of the weight of the wood when oven dry. The weight of the water in wet wood can be twice that in wood that is oven dry. . . .

In living trees the amount of moisture varies widely between different species, among individual trees of the same species, among different parts of a tree, and between sapwood and heartwood. Many softwoods have a large proportion of moisture in the sapwood and far less in the heartwood, while most hardwoods have about the same moisture content in both sapwood and heartwood. The extreme limits of moisture content in green softwoods can be shown by comparing the moisture content of the heartwood of Douglas fir and southern pine, which may be as low as 30%, to the moisture content of the sapwood of cedars and redwoods, which may be as high as 200%.

Moisture in green wood is present in two forms: in the cell cavities as free water and within the cell fibers as absorbed water. When wood dries, its cell fibers give off their absorbed water only after all the free water is gone and the adjacent cell cavities are empty. The point at which the fibers are still fully saturated, but the cell cavities are empty, is called the fiber saturation point. In most species this occurs at about 30% moisture content. The significance of this condition is that it represents the point at which shrinkage begins. Even lumber cut with a green moisture content as high as 200% [of dry weight] can dry to the fiber saturation point (30% moisture content) with no shrinkage of the wood. Only when the cell fibers begin to give off their absorbed water and start to constrict does the wood shrink.

Therefore, all of the shrinkage wood can experience takes place between its fiber saturation point and a theoretical moisture content of 0% (oven-dry condition). Within this range, shrinkage is proportional to moisture loss. Once wood has reached a 30% moisture content or below that level, for every 1% loss or gain in moisture content, it shrinks or swells, respectively, about 1/30 of the total expansion or contraction. For example, at 15% moisture content wood will have experienced half of its total possible shrinkage. However, wood in service almost never reaches a 0% moisture content because of the influence of water vapor in the surrounding atmosphere. Therefore, the total possible shrinkage is far less important than the probable shrinkage under ordinary conditions.

The variations of the dimensions of wood with the moisture content of the surrounding air causes wood to be a less desirable construction material than materials properties of wood by reducing the difference between the fiber saturation point and the oven dried constant weight condition.

Other common materials are also primarily cellulose. Natural fibers such as cotton, linen, and paper are composed primarily of cellulose fibers. The process of the invention may be applied to these materials or any other cellulose fiber material to provide waterproofing and other advantages.

### EXAMPLE 1

Waterproofing

In a simple test to demonstrate the ability of the polymer to water proof cellulose material samples of pine wood, cotton balls, oak, birch and maple are treated with a copolymer consisting substantially of hydoxymethyl endblocked dimethylsiloxanes having a viscosity of 1000 cSt by immersion in a stirred bath of copolymer at room temperature for one hour and allowing the article to dry to constant weight after treatment. When the treated articles were sprayed with liquid water the water beaded and did not wet the treated surface, where as untreated samples of the same material were quickly wet with little or no evidence of water beading.

### EXAMPLE 2

Interior Waterproofing of Wood

A copolymer solution suitable for treating wooden materials according the invention is prepared by slowly adding 20 parts of a silicone polymer obtained from GT Products, Inc. of Grapevine, Tex. designated X5814 to 80 parts of Conosol 145. When the addition is complete, 4 foot sections cut from building grade 8 foot pine 2×4s are immersed in a tank of circulating solution for one hour and dried to constant weight. The untreated 4 ft section of each 2×4 was marked and used as a control in subsequent tests.

Randomly selected treated and the matching untreated 2×4s are split and the interior portions of the split wood was sprayed with water. The treated wood showed water beading even in the center of the material while all surfaces of the untreated portions water beading even in the center of the material while all surfaces of the untreated portions were readily wet, showing complete penetration of the copolymer to the interior of the wood.

### EXAMPLE 3

Insect Protection and Waterproofing

A solution containing 80 parts Conosol 145, 15 parts X5814 and 5 parts Cedar Oil available from CedarCide, Inc. of Spring, Tex. was prepared as described in example 2. When the matched 2×4s were split the beading of water sprayed on the interior surfaces demonstrated penetration of the copolymer to all portions of the wood.

When filter papers composed of cellulose fibers were treated with the mixture and tested against untreated controls, worker termites readily feed on the untreated paper but no feeding was observed on the treated papers.

### EXAMPLE 4

Bending Strength Increase

Two substantially equivalent nominal 8 feet Pine 2×4s were purchased from a retail chain home improvement center in the Houston, Tex. metropolitan area. One board was treated according to the invention by immersion in a composition of 80% Conosol 145, 15% X5814, and 5% cedar wood oil for one hour, and then being permitted to air dry for several days. The other board was not treated. The boards were supported at the ends by being placed on blocks and a 20 kg weight (44 pound) was placed at the center and the deflection of the board was measured. The treated board deflection was more than 50.8 cm (2 inches) less than the deflection of the untreated board.

### EXAMPLE 5

Hygroscopic Behavior

Two samples of 22.5 mm×89 mm (1 in. by 4 in.) southern short leaf pine were dried to constant weight by heating in an oven at 110 deg. C. and weighing daily until no weight change was observed. One sample of the wood was then treated as described above, dried for several days and then placed in a chamber maintained at 100% humidity. The samples were weighed daily and the weights in grams are reported in Table 1 below.

TABLE 1

| | Sample | | | | | | |
|---|---|---|---|---|---|---|---|
| | 1 | 2 | 3 | 4 | 5 | 6 | 7 |
| #45-A-1 | 298 | 298 | 298 | 298 | 298 | 299 | 298 |
| untreated | 285 | 293 | 297 | 301 | 306 | 308 | 310 |

As shown above the treated sample did not gain weight by absorbing moisture from the atmosphere, while the untreated control showed the typical hygroscopic behavior of wood.

We claim:

1. A method for waterproofing cellulose fibers that comprises contacting with the cellulose fibers to be treated with a copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and maintaining the contact for a time sufficient to establish a change in the cellulose fiber that provides a decrease in the hydrophilic quality of the fiber decreasing the wetting of the fiber by liquid water.

2. The method of claim 1 that further comprises mixing a cross-linking agent with the copolymer that comprises a siloxane polymer of the general formula: (MₐD_{b}T_{c}Q_{d})ₓ formula to which the following parameters apply: the ratio of a/(c+d) is between 0 and 4; the ratio of b to the rest is not subject to limitation provided the final cross-linking agent viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable group.

3. The method of claim 1 that further comprises providing a crosslinking catalyst mixed with the copolymer.

4. The method of claim 3 wherein the catalyst is a tetraalkyl titanate or tetraalkyl zirconate.

5. The method of claim 1 comprising diluting the copolymer with an aliphatic solvent composed primarily of C₇-C₁₆ paraffinic, cycloparaffinic and isoparaffinic hydrocarbons containing less than about 0.5% aromatic hydrocarbons.

6. The method of claim 5 comprising wherein the aliphatic solvent is composed primarily of C₉-C₁₄, paraffinic, cycloparaffinic and isoparaffinic hydrocarbons.

7. The method of claim 5 comprising wherein the aliphatic solvent is composed primarily of C₁₀-C₁₃, cycloparaffinic and isoparaffinic hydrocarbons.

8. The method of claim 5 comprising the aliphatic solvent Conosol 145.

9. The method of claim 5 wherein a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil .

10. The method of claim 9 wherein the oil is from the group consisting of cedar oil, cinnamon oil, citronella oil, clove oil, eucalyptus oil, juniper oil, tall oil, and pine oil.

11. The method of claim 1 wherein the oil is cedar oil.

12. The method of claim 1 wherein R groups may be the same or different and each is a lower alkyl group of no more that four carbons.

13. The method of claim 1 that wherein all non-terminal copolymer R groups are methyl.

14. The method of claim 2 that comprises a crosslinker having wherein an R group in an alkoxy group is an alkyl group comprising from 1 to 4 carbon atoms.

15. The method of claim 14 that further comprises methyl groups at each non-alkoxy position.

16. An article of manufacture comprising cellulose fibers processed according to claim 1.

17. An article of manufacture comprising cellulose fibers processed according to claim 5.

18. An article of manufacture comprising cellulose fibers processed according to claim 8.

19. An article of manufacture comprising cellulose fibers processed according to claim 9.

20. An article of manufacture comprising cellulose fibers processed according to claim 11.

21. An article of manufacture comprising wood processed according to claim 1.

22. An article of manufacture comprising wood processed according to claim 11.
